(19) United States
(12) Patent Application Publication
(10) Pub. No.: US 2007/0160406 A1
(43) Pub. Date: Jul. 12, 2007

(54) Printer

(75) Inventors: Raymond W. Coles, Dorset (GB); Andrew S. R. Loveless, Dorset (GB); Andrew M. Pass, Dorset (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: ULTRA ELECTRONICS LIMITED, Greenford ,Middlesex (GB)

(21) Appl. No.: 10/571,377

(22) PCT Filed: Sep. 10, 2004
(86) PCT No.: PCT/GB04/03889

§ 371 Date: Jan. 4, 2007

(30) Foreign Application Priority Data
Sep. 12, 2003 (GB) 0321460.8

(51) Int. Cl. B41J 13/12

(52) U.S. Cl. 400/521

(57) ABSTRACT

A printer (2) for printing security cards (14) in which two pairs of pinch rollers (22, 24) convey a substrate (14) past a print head (20). A cam follower (42) is driven by a cam (40) and is mounted on shafts of lower rollers (22a, 24a) of the pinch rollers and a shaft of a platen roller (32). The cam follower can be moved to act against upper rollers (22b, 24b) of the pinch rollers and the print head, in order to bring the pinch rollers or the print head in and out of engagement with the substrate. The printer may also include a return device (70) to urge the substrate back towards a pair of pinch rollers. The rollers can then be reversed, enabling multiple passes of the substrate past the print head or a magnetic strip encoder (36). The substrate can also be inserted and removed via a single slot (12) in the housing of the printer.

The present invention relates to a printer and in particular, but not exclusively, to a card printer for printing security cards.

Card printers are known for printing, either in colour or black and white, images and text onto a card substrate to generate a security card. The cards produced are generally of a similar size to a standard credit card. It is also known for the printers to print one or more security features onto the card, such as repeated logos, for example by overheating in localised areas a deposited plastic surface of the card. An example of a printer of the latter type is described in the applicants co-pending British patent applications GB 0008287.5 and GB 0305471.5. Card printers of this kind generally use a thermal printing head in conjunction with a dye carrying film, the thermal printer head thermally transferring the ink from the carrier film onto the card. The current known printers of this kind are generally provided with at least a card feeding mechanism to transfer a card to be printed from a stored plurality of cards to the actual printing mechanism of the printer, and in some cases also include a printed card delivery mechanism. The card feed and delivery mechanisms greatly increase the complexity of the printer and, due to their complexity, are prone to failure or malfunction. Common causes of failure are roller polishing, where the surface of the card transport feed rollers become polished smooth through use and as a result do not grip the card properly, and static attraction between individual cards in a stack that prevents single cards from being fed properly. Consequently, not only is the cost of manufacture of the printer increased due to the increased complexity of the printer, but significant further expenses are generally incurred in dealing with the faulty mechanisms in customers' printers.

According to a first aspect of the present invention there is provided a printer comprising a print head arranged to print an image on a substrate, first and second substrate transport mechanisms arranged to convey the substrate past the print head and a transport control mechanism comprising a cam follower arranged to move the print head and the first and second substrate transport mechanisms in and out of engagement with the substrate.

The cam follower is preferably in engagement with a cam lobe that is preferably driven in rotation to control movement of the cam follower.

Additionally or alternatively, the first and second transport mechanism may be arranged to move the substrate bi-directionally with respect to the print head. The printer may further comprise a substrate return device arranged to bring the substrate into engagement with one of the substrate transport mechanisms in a direction towards the print head. The substrate return device preferably comprises a resilient member against which the substrate may be urged by one of the transport mechanisms, the resilient member in turn urging the substrate towards the transport mechanism when the transport mechanism is reversed.

At least one, and preferably both, of the first and second substrate transport mechanisms comprises an upper and lower pinch roller arranged to receive the substrate therebetween. Preferably the or each upper pinch roller is arranged to be moved out of contact with the substrate by means of the cam follower.

Additionally or alternatively, the cam follower is arranged such that the or each upper pinch roller is not in contact with the substrate when the print head is in engagement with the substrate.

Additionally or alternatively, the cam follower is arranged such that at least one upper pinch roller is moved out of contact with the substrate immediately prior to an edge of the substrate moving past the drive roller.

A printer in accordance with an embodiment of the present invention is described below, by way of illustrative example only, with reference to the accompanying Figures, of which:

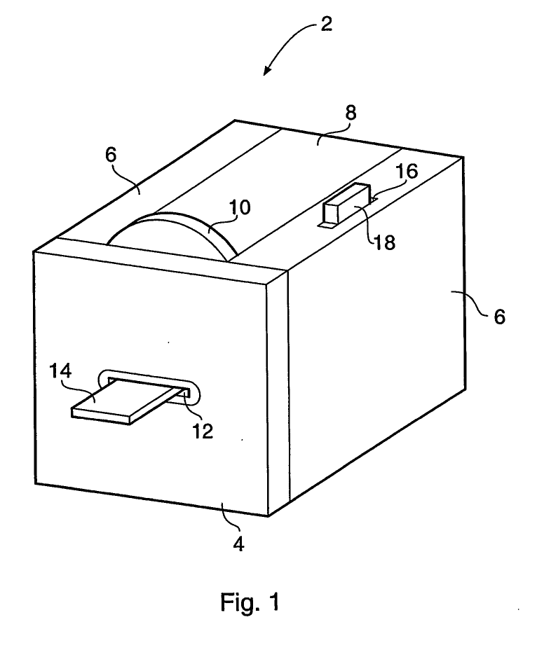

FIG. 1 schematically illustrates a printer according to an embodiment of the present invention;

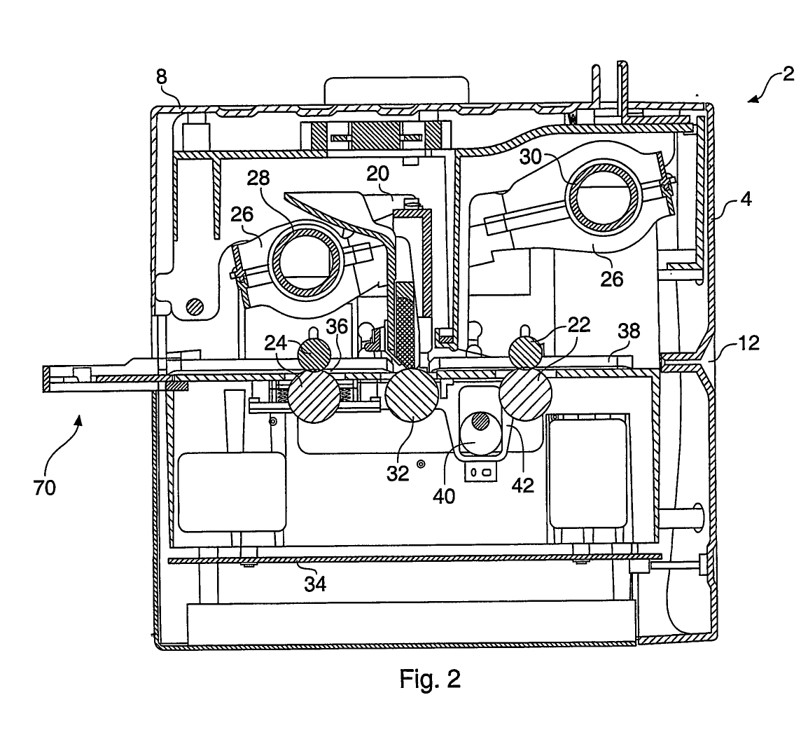

FIG. 2 is a cross sectional view of the printer illustrated in FIG. 1;

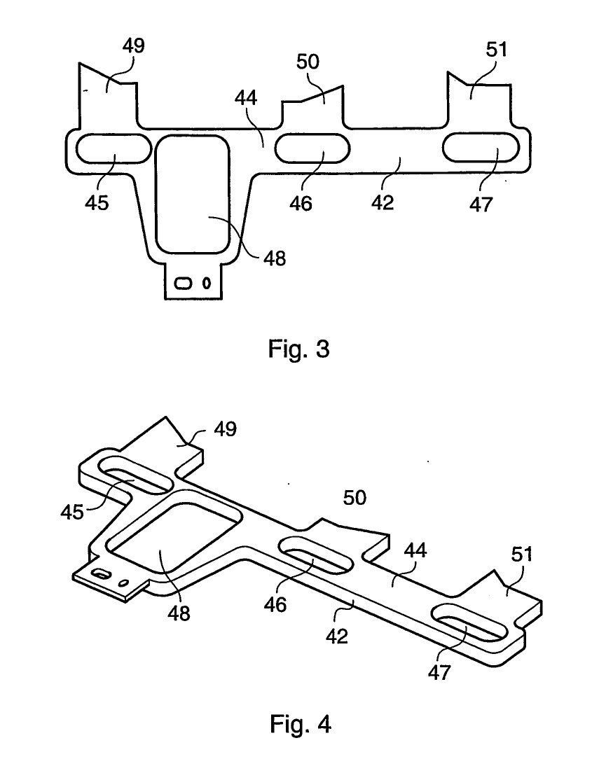

FIGS. 3 and 4 illustrate a cam follower used within the printer shown in FIG. 1;

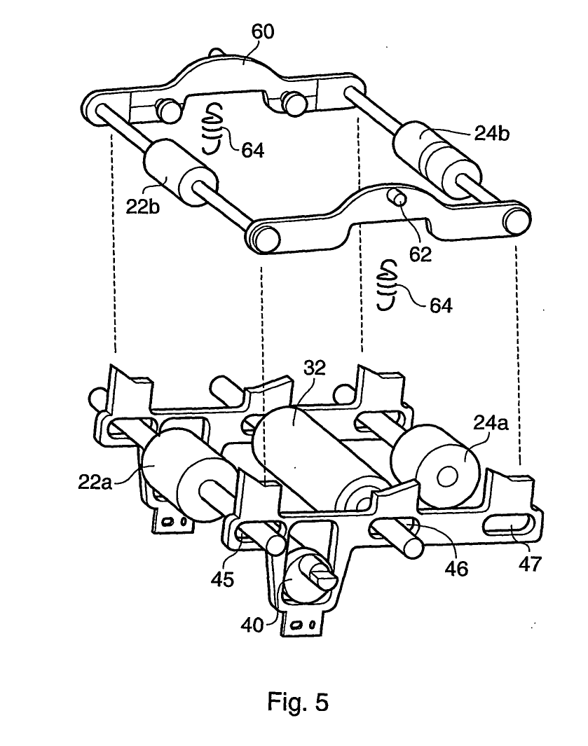

FIG. 5 illustrates a pinch roller mechanism and drive roller arrangement in corporation with the cam follower illustrated in FIGS. 3 and 4;

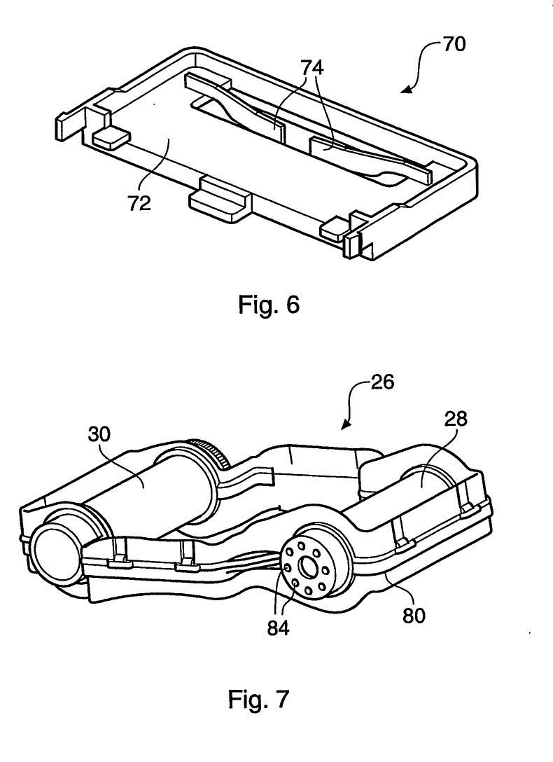

FIG. 6 is a perspective view of a card return mechanism according to an embodiment of the present invention;

FIG. 7 is a perspective view of a film cartridge for use in the printer illustrated in FIGS. 1 and 2;

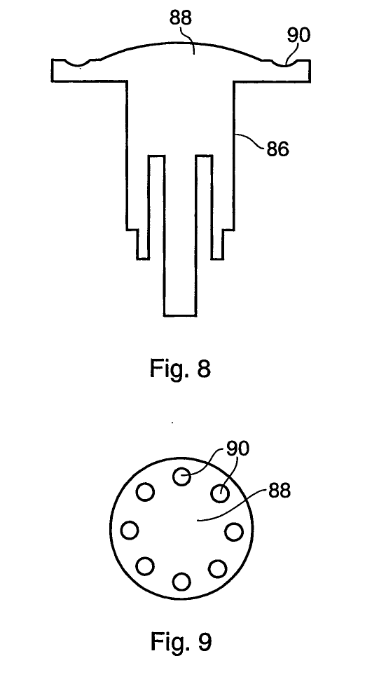

FIG. 8 is a cross sectional view of a film cartridge drive sprocket in accordance with an embodiment of the present invention; and

FIG. 9 is an end view of the drive sprocket illustrated in FIG. 6.

Referring to FIG. 1, a schematic representation of a printer according to an embodiment of the present invention is illustrated. The printer 2 comprises a case made up of a number of separate panels, including a front panel 4, a pair of side panels 6 and a cover panel 8 that can be opened to provide access to the interior of the printer 2. To facilitate the opening of the cover panel 8, a handle 10 is provided. A slot 12 is provided in the front panel 4 through which a card substrate 14 can be introduced and dispensed before and after printing. In the particular embodiment illustrated in FIG. 1, a further slot 16 is provided on the upper surface of one of the side panels 6, the slot 16 defining an aperture into which a removable memory device 18, such as a radio frequency (RF) identity tag, can be located.

FIG. 2 illustrates a cross section through a vertical plane of the printer 2 shown in FIG. 1. Where appropriate, like parts illustrated in FIG. 1 are referenced in FIG. 2 with like reference numerals. The printer 2 comprises a thermal print head 20 that, in use, presses a dye film (not illustrated) against a card to be printed. The card 14 is moved with respect to the print head 20 by two pairs of motor driven pinch rollers 22 and 24. The pinch rollers can be driven bi-directionally such that the card can make multiple passes underneath the thermal print head 20. Simultaneously, thermally transferable ink on thermal dye film is moved past the print head 20. The thermal dye film is held in a cassette 26. Typically the dye film contains five separate panels of thermally transferable ink arranged in sequence. The panels are yellow, magenta and cyan so as to give full colour printing, a black panel so that black graphics or text can be accurately reproduced on the card, and a transparent thermally depositable layer that can be placed over the printed image on the card 14 so as to protect the image carried by the card. The dye film is generally transferred from a source spool 28 to a take-up spool 30 that is driven by a take-up motor (not shown). A platen roller 32 is located directly underneath the thermal print head 20 and provides support for the card 14 during a printing operation. The platen roller 32 is also driven in synchronisation with the pair of pinch rollers 22 and 24 by means of a drive belt (not shown). The motors driving the pinch rollers 22, 24 and the platen roller 32, the take-up motor and the thermal print head 20 are all under the control of a central processor held on a printed circuit board 34. According to some embodiments of the present invention a magnetic encoding head 36 may also be provided in the printer 2. This allows a magnetic strip provided on the lower surface of the card 14, the lower surface being the opposite surface to that which is printed upon, to be magnetically encoded with further security information. In operation, the magnetic encoding head 36 is urged against the lower surface of the card 14 due to the action of one or more springs in a conventional manner.

In operation, a card substrate 14 is inserted into the printer through the slot 12 in the front panel 4. Opposing side rails 38 are provided to guide the passage of the card 14 and to ensure it is in the desired orientation with respect to the print head 20. The card 14 must be manually inserted to an extent that the leading edge of the card 14 is brought into contact with the first pair of pinch rollers 22. Appropriately provided and controlled sensors detect when the card is sufficiently inserted such that the first pair of pinch rollers 22 can grip the card 14 and continue to drive the card towards a print head 20. During the actual printing operation, the upper roller of each of the first and second pairs of pinch rollers 22, 24, which are not rotatably driven, are raised above and out of engagement with the card 14, such that only the driven platen roller 32 continues to transport the card 14 through the printer mechanism. Once clear of the print head 20, the upper rollers of the pairs of pinch rollers 22 and 24 are once again lowered into contact with the card and the print head 20 is raised clear of the card. The card can then be transported in the opposite direction towards the slot 12 to either position the card for a further printing operation using a differently coloured panel of the dye film, or to eject the card 14 from the printer through the slot 12 at the end of a printing action. The raising and lowering of the upper pinch rollers and the print head 20 is controlled using a cam 40 and cam follower 42.

Side and perspective views of the cam follower 42 are shown in FIGS. 3 and 4 respectively. It should be noted that the cam follower shown in FIGS. 3 and 4 is orientated at 180° to that shown in FIG. 2. The cam follower 42 has an elongate body portion 44, which when the cam follower is fitted to the printer 2 is in a substantially horizontal orientation, in which three elongate apertures 45, 46, 47 are formed. The three elongate apertures 45 to 47 each receive an end of the cylindrical shafts on which the lower rollers of the pair of pinch rollers 22, 24 and the platen roller 32 are mounted. The three elongate apertures are substantially evenly spaced apart. Depending from the elongate section 44 is a further body section in which a vertically orientated aperture 48 is formed, which in use receives the cam member 40. Formed substantially above each of the horizontal elongate apertures 45 to 47 are three cam profiles 49 to 51. The central cam profile bears against a portion of the print head 20 when in use, whilst the outer two profiles 49, 51 bear against the shafts on which the upper rollers of the pinch roller pairs 22, 24 are located.

The arrangement of the cam 40, cam follower 44, pinch rollers 22, 24 and platen roller 32 is illustrated in FIG. 5. The lower rollers 22a and 24a of the pinch rollers 22 and 24 are mounted on respective cylindrical shafts that pass through the outer elongate apertures 45, 47 of the cam follower 44. The platen roller 32 is carried on a further shaft that passes through the central elongate aperture 46. The cylindrical shafts on which the upper rollers of the pinch rollers are mounted are in turn are mounted on an upper pinch roller carriage 60 comprising first and second side members. The ends of the shafts carrying the upper pinch rollers 22b and 24b rest on the upper surfaces of the respective cam profiles 49, 51 of the cam follower 44. The cam 40 has a cylindrical profile and is rotatably mounted in an offset manner. The width of the aperture 48 of the cam follower 44 in which the cam 40 is located is substantially the same as the diameter of the cylindrical cam 40. Consequently, a rotation of the cam 40 through 180° imparts a horizontal motion on the cam follower 44. A cam follower 44 is free to move with respect to the lower pinch rollers 22a and 24a and the platen roller 32 due to the elongate apertures 45 to 47. The upper pinch roller carriage 60 has a pair of lugs 62 formed on respective side members of the carriage, with each lug being engaged with a vertical slot within the body of the printer (not shown) this restrains the pinch roller carriage 60 from moving horizontally but allows one or both of the upper pinch rollers 22b and 24b to move vertically with respect to their respective lower pinch rollers. The vertical motion is imparted to the upper pinch rollers 22b and 24b by the horizontal passage of the upper cam profiles 49 to 51. The upper pinch roller carriage 60 is urged towards the lower pinch rollers 22a and 24a by means of one or more springs 64. The upper cam profiles 49 to 51 are shaped to ensure certain actions only occur at the correct times during the printing process. At the beginning of a printing process the cam 40 and cam follower 42 are in an initial position, as illustrated in FIG. 1, in which both upper pinch rollers 22b, 24b are lowered in contact with their respective lower pinch rollers 22a, 24a. Both lower pinch rollers and the platen roller are rotatably driven, so that as a card 14 is inserted into the printer and is brought into contact with the jaws of the first pair of pinch rollers 22 it is driven towards the print head 20. As the card 14 is brought under the print head 20 the cam is rotated, thus imparting horizontal motion to the cam follower 42 to cause the print head 20 to be lowered and both upper pinch rollers 22b, 24b to be lifted. The central upper cam profile 50 is shaped such that the leading edge of a card substrate 14 is already underneath the print head 20 before the print head 20 is lowered to commence a printing operation. If the print head 20 was lowered before the leading edge of the card substrate 14 was underneath it the dye film could be cut by the interaction of the print head against the leading edge of the card 14. In addition to which, the print head 20 might be damaged as the leading edge of the card 14 came into contact with it. All three upper cam surfaces 49 to 51 are shaped such that at no time are both upper pinch rollers 22b and 24b and the print head 20 simultaneously in contact with the upper surface of the card substrate 14. The second, or rear, upper pinch roller 24b is lifted away from the card to prevent the leading edge of the card from striking the upper pinch roller as it is driven past the print head 20 during printing. Although the second lower pinch roller is being driven in synchronism with the platen roller, should the card strike the upper pinch roller during printing a momentary variation in the speed of the card will be caused. This would produce a band of colour variation across the card.

At the end of a printing operation the cam 40 is again rotated and the cam follower 42 raises the print head 20 and lowers both upper pinch rollers. The direction of rotation of the pinch rollers and platen roller is reversed to either reposition the card for subsequent printing operations or to eject the card 14 from the printer. The distance between the first and second pairs of pinch rollers 22, 24 is less than the length of a card 14 to ensure the card can be driven between the two pairs of rollers.

To perform a magnetic encoding operation the cam 40 and cam follower 42 again are in the initial position shown in FIG. 1 and thus the inserted card 14 is initially driven through the printer by virtue of the first pair of pinch rollers 22. As the magnetic coding head 36 is located substantially coincident with the second pair of pinch rollers 24, the card is driven by the second pinch rollers during the encoding process. However, as the card engages with the second pair of pinch rollers 24, and whilst the trailing edge of the card is still in engagement with the first pair of pinch rollers 22, the cam 40 is rotated by an amount just sufficient to cause the cam profile 49 associated with the first upper pinch roller 22b to take the weight of the first upper pinch roller. This prevents the first upper pinch roller 22b rolling off the card 14 as it clears the first pair of pinch rollers, as this tends to give a slight ‘kick’ to the card that causes a variation in the speed of the card that can degrade the magnetic encoding process. The cam profiles 49, 51 associated with the first and second upper pinch rollers are not identical to allow the first upper pinch roller 22b to be disengaged from the card whilst leaving the second upper pinch roller 24b in engagement with the card. On completion of an encoding operation the card is driven towards the first pair of pinch rollers and the cam 40 and follower 42 are returned to their initial position, thus allowing the first upper pinch roller to again come into engagement with the card. As previously mentioned, the magnetic encoding head 36 is located substantially coincident with the second pair of pinch rollers 24, as illustrated in FIG. 2. Consequently, during the magnetic encoding procedure the card substrate must be fully passed through the second pair of pinch rollers 24 in a direction away from the slot 12 provided in the front face of the printer. To avoid the need for a further set of pinch rollers to return the card 14 into engagement with the second set of pinch rollers 24 to allow the card to be passed back through the printing mechanism, a spring return mechanism 70 is provided. Referring to FIG. 6, the spring return mechanism 70 comprises a substantially flat lower surface 72 over which the card 14 passes as it is driven out of the rear pinch rollers 24. A pair of leaf springs 74 are fixed at one of their ends to the lower surface 72 and are curved towards the second pair of pinch rollers. The distance between the forward most portions of the leaf springs 74 and the contact point of the second pair of pinch rollers 24 is arranged to be slightly less than the length of the card substrate 14, such that in use as the card is driven out of the second pair of pinch rollers 24 away from the slot 12, the forward edge of the card 14 is brought into contact with the leaf spring 74. The continued operation of the pinch rollers 24 urges the card away from the pinch rollers against the action of the leaf spring 74 so that the leaf springs are tensioned against the card 14. Consequently, the card 14 is maintained against the second pair of pinch rollers 24 by the action of the leaf spring 74, such that at the end of the magnetic encoding process when it is desired to drive the card back through the printer mechanism towards the slot 12, the edge of the card in contact with the pinch rollers 24 is urged towards the pinch rollers by the leaf spring 74 and is therefore gripped by the pinch rollers 24 when they are driven in the appropriate direction.

A perspective view of the dye film cartridge 26 is shown in FIG. 7. The cartridge 26 comprises a cartridge frame 80 that is substantially rectangular in shape, although a midsection of the cartridge is stepped outwards on either side of the cartridge to create a middle section wider than the remainder of the cartridge. The print head mechanism 20 of the printer passes through this widened middle section of the cartridge 80 when in use. Mounted at either end of the cartridge 80 is the source spool 28 and the take-up spool 30. The take-up spool has a drive sprocket formed on at least one end thereof. On one end of the drive sprocket 82 around its circumference are formed a plurality of drive teeth. The drive teeth are involute gear teeth that preferably comply with Standard BS4582 and preferably are 48 in number. In use, the drive sprocket is in engagement with a driven sprocket mounted within the printer body and driven by a corresponding motor. The driven sprocket preferably comprises a 48 tooth involute gearform, also preferably complying with BS4582. The two gear forms mesh together providing means for transferring the rotation force of the drive motor to the take-up spool 30.

On an end surface of the source spool 28 there are formed a plurality of raised “pips” 84 that are approximately hemispherical in shape. These “pips” are formed in a circle towards the outside edge of the source spool 28 and are angularly displaced from one another at substantially equal intervals. These engage with correspondingly shaped “dimples” 90 formed in the end face of a tacho drive 86, illustrated in FIGS. 8 and 9. The tacho drive 86 operates a tacho (not shown) that is used to ensure synchronisation between the dye film drive mechanism and the print head and card feed mechanisms.

The tacho drive 86 is mounted resiliently to the body of the printer 2 such that the end face of the source spool 28 can be brought into engagement with the end face 88 of the tacho drive 86 without the “pips” and “dimples” meshing together. As a result, on inserting a film cartridge 26 into the printer body there is no requirement to accurately line up the “pips” and indentations together, the resilience provided being sufficient to allow the cartridge 26 to be correctly inserted regardless of the orientation of the “pips” 84. The “pips” and “dimples” will mesh together during the initial rotation of the source spool 828.

Referring back to FIGS. 1 and 2, the print head mechanism 20 is located on the underside of the upper panel 8 of the printer 2. The upper panel 8 is pivotally engaged with the printer body towards the rear of the printer to allow the panel to be pivoted upwards and towards the rear of the printer. This provides access to the body of the printer to replace the film cartridges 26 as required. The handle 10 on the upper panel 8 also functions as a retaining catch to secure the upper panel 8 to the body of the printer. Two catches are provided at either side of the upper panel 8 in the region of the handle 10 that can be retracted out of engagement with their respective catches by operation of the handle 10.

1. A printer comprising a print head arranged to print an image on a substrate, and first and second transport means arranged to convey the substrate past the print head, in which the print head and the first and/or second transport means are arranged to be brought in and out of engagement with the substrate by means of a cam follower.

2. A printer as claimed in claim 1, in which the cam follower is driven using a rotatable cam.

3. A printer as claimed in claim 2, in which a central axis of the cam is offset from an axis of rotation of the cam.

4. A printer as claimed in any preceding claim, in which the cam follower comprises at least one cam profile which acts against the first and/or second transport means and the print head in order to move the first and/or second transport means and the print head in and out of engagement with the substrate.

5. A printer as claimed in any preceding claim, in which the cam follower is movable in a direction of movement of the substrate.

6. A printer as claimed in any preceding claim, in which shafts of the first and second transport means pass through apertures in the cam follower such that the cam follower is mounted on the shafts.

7. A printer as claimed in any one of the preceding claims, in which the first and/or second transport means comprises a pair of pinch rollers arranged to receive the substrate therebetween.

8. A printer as claimed in claim 7, in which a first roller of the pair of pinch rollers of the first and/or second transport means is arranged to be movable relative to a second roller of the pair of pinch rollers, such that the first roller can be moved in and out of contact with the substrate.

9. A printer as claimed in claim 8, in which the second roller of the first and/or second transport means is arranged to be rotatably driven in order to convey the substrate past the print head.

10. A printer as claimed in any one of the preceding claims, in which the first and second transport means are arranged to convey the substrate bi directionally.

11. A printer as claimed in claim 10, further comprising a substrate return device arranged to bring the substrate into engagement with the second transport means in a direction towards the print head.

12. A printer as claimed in claim 11, in which the substrate return device comprises a resilient member against which the substrate is urged by the second transport means when the second transport means conveys the substrate in a first direction, such that the substrate return device urges the substrate towards the second transport means to convey the substrate in a second direction when the direction of the second transport means is reversed.

13. A printer as claimed in any one of the preceding claims, in which the print head is not in engagement with the substrate when the first and/or second transport means is/are in engagement with the substrate.

14. A printer as claimed in claim 13, in which a thermal dye film is held within a cassette, and is moved from a source spool, past the print head, and onto a take-up spool.

15. A printer as claimed in claim 14, in which an end of the source spool is in engagement with a tacho drive which drives a tacho, which ensures that there is synchronisation between movement of the thermal dye film and movement of the substrate.

16. A printer as claimed in claim 15, in which a profile of the end of the source spool conforms with a profile of a corresponding end of the tacho drive, such that drive is transferred from the source spool to the tacho drive.

17. A printer as claimed in claim 19, in which drive is not fully transferred during rotation of the source spool until the profiles come into alignment.

18. A printer as claimed in claim 16 or 17, in which one or more protuberances on the end of the drive spool engage with one or more recesses on the corresponding end of the tacho drive.

19. A printer as claimed in any one of the preceding claims, in which the first and/or second transport means is arranged to be brought at least partially out of engagement with the substrate prior to an edge of the substrate moving past the first or second transport means.

20. A printer as claimed in any one of the preceding claims, in which the first and second transport means are positioned at opposite sides relative to the print head.

21. A printer as claimed in any one of the preceding claims, in which a third transport means is arranged to convey the substrate past the print head when the first and/or second transport means is/are out of engagement with the substrate.

22. A printer substantially as described with reference to, and as shown in, FIGS. 1 to 9.
